(19) United States
(12) Patent Application Publication
(10) Pub. No.: US 2013/0169664 A1
(43) Pub. Date: Jul. 4, 2013

(54) METHOD OF DISPLAYING POINTS OF INTEREST

(71) Applicant: Harman Becker Automotive Systems GmbH, Karlsbad (DE)

(72) Inventors: Marek Strassenburg-Kleciak, Garching (DE); Markus Radner, Munchen (DE)

(73) Assignee: Harman Becker Automotive Systems GmbH, Karlsbad (DE)

(21) Appl. No.: 13/729,724

(22) Filed: Dec. 28, 2012

(30) Foreign Application Priority Data
Dec. 28, 2011 (EP) 11195963.1

(51) Int. Cl. G09G 5/02

(52) U.S. Cl. CPC G09G 5/02
USPC 345/589

(57) ABSTRACT

A method of displaying points of interest in a perspective view of a geographical area on a display of a navigation device is provided. In the method, a perspective view of the geographical area is displayed on the display of the navigation device. Further, points of interest are displayed as graphical symbols in the perspective view, wherein the size of each graphical symbol is dependent on the distance of the respective point of interest from a view point of the perspective view, such that graphical symbols for points of interest located further away from the view point are displayed smaller than graphical symbols for points of interest located closer to the view point. Each point of interest is associated with a point of interest-category.

### 1. CLAIM OF PRIORITY

This patent application claims priority from EP Application No. 11 195 963.1 filed Dec. 28, 2011, which is hereby incorporated by reference.

### 2. FIELD OF TECHNOLOGY

The invention relates to a method of displaying points of interest in a perspective view of a geographical area and to a navigation device implementing such method.

### 3. RELATED ART

Navigation systems are used for guiding the driver of a vehicle to a destination. Other applications include the use by pedestrians, bikers, boaters and pilots for finding a destination or for obtaining information on the area they are travelling in. For this purpose, modern navigation devices are equipped with a display on which the actual position of the navigation device and the geographical region in proximity to this position can be shown. As an example, a map section, a satellite image or a topology image of the region may be shown on the display of the navigation device.

More advanced systems feature perspective views of the geographical region, which may in a simple case include a view from an elevated angle onto a map section, and which in a more complex case can comprise rendered objects, such as buildings, mountains, or the like. The view point of the perspective view can coincide (at least in horizontal direction) with the position of the navigation device or may be located in proximity thereto.

To provide the user of a navigation device with information on interesting places, such as monuments or buildings, or information on facilities such as restaurants and gas stations, it is known to provide graphical indications in the displayed geographical region which are generally termed points of interest (POIs). The POIs can be displayed as pictograms, which indicate their meaning through their pictorial resemblance to the facility or site for which they stand.

In a perspective view, the pictograms for all POIs are generally displayed at the same size irrespective of their position in the perspective view, since making the pictograms smaller would render them unrecognizable. Thus, the perspective impression of the perspective view is degraded. Further, it becomes confusing and unclear to a user of the navigation device in which distance the POIs are actually located.

It is desirable to provide POIs to the user of the navigation device such that the perspective impression is maintained. At the same time, the POIs should remain recognizable for the user.

### SUMMARY OF THE INVENTION

According to an embodiment of the invention, a method of displaying points of interest in a perspective view of a geographical area on a display of a navigation device is provided. The method comprises the steps of displaying a perspective view of the geographical area on the display of the navigation device and displaying points of interest as graphical symbols in the perspective view. The size of each graphical symbol is dependent on the distance of the respective point of interest from a view point of the perspective view, such that graphical symbols for points of interest located further away from the view point are displayed smaller than graphical symbols for points of interest located closer to the view point. A perspective impression of the distance to the points of interest may thus be obtained. Each point of interest is associated with a point of interest-category. To different point of interest-categories, different display colors are assigned. In the method, at least graphical symbols having a size smaller than a predetermined minimum size are displayed in the display color of the point of interest-category associated with the respective point of interest.

By using different display colors for the different POI categories, the user of the navigation device may still be capable of identifying the POI category even if the graphical symbol for the POI is small. Thus, a perspective impression can be maintained while at the same time, the user still obtains an indication on the category of the POI. The predetermined minimum size may for example be a size at which the graphical symbol becomes difficult to be recognized on the display. It can be different for different types, sizes or resolutions of the display.

Displaying the graphical symbol in the display color does not imply that it needs to be colored entirely in the display color. It is sufficient that a part of the graphical symbol has the display color so that the display color is recognizable. For example, each graphical symbol may be provided with a border having the display color, while the inner parts of the graphical symbol may be displayed in one or more default colors, e.g., including black and white. It is also possible that inner parts of the graphical symbol are displayed in the display color. Typically, a graphical symbol may comprise an inset pictogram indicating the point of interest category; for example, it is possible that the inset pictogram is displayed in the display color, while remaining parts of the graphical symbol are displayed in the default colors, etc. It further scenarios, a background of the graphical symbol may be displayed in the display color. For example, the pictogram may be arranged on the background and/or the background may be enclosed by the border. As can be seen from the above, it may be possible to display various parts of the graphical symbol, alone or in combination, in the display color.

For example, it may be possible that corresponding parts of graphical symbols of different point of interest-categories are displayed in the respective display color. For example, for graphical symbols relating to the point of interest-category “fuel station”, as well as for graphical symbols relating to the point of interest-category “hospital”, both, the border and/or background and/or pictogram of the graphical symbol may be displayed in the different display colors.

The view point may be the point from which a virtual observer sees the perspective view; it may be located close to the actual position of the navigation device (and possibly elevated by a certain distance), it may be user selected (e.g., when panning in the perspective view) or the like.

In an embodiment, the graphical symbols may be displayed in the display color of the point of interest category associated with the respective point of interest irrespective of their size. Accordingly, all POIs in the perspective view of the same category may be displayed in the display color, which makes them easily identifiable.

At least the graphical symbols having a size larger than the predetermined minimum size may be pictograms indicative of the point of interest-type or the point of interest-category of the respective point of interest. The user may thus identify which type or category a POI is by simply looking at the perspective view shown on the display. If the graphical symbols are further displayed in the display color irrespective of their size, then a user can further easily recognize which display color is associated with which POI category, since the pictograms indicating the POI type/category are shown in the display color for the respective POI category.

Displaying the graphical symbol in the display color may occur in different ways. Parts or all of the graphical symbol may be filled in the display color, or lines or borders may be in the display color. As an example, at least 30% or at least 50% or the filled pixels of the graphical symbol may be shown in the display color.

In an embodiment, the graphical symbols having a size smaller than the predetermined minimum size are geometric shapes that are solidly filled in the display color assigned to the point of interest-category of the respective point of interest. As an example, the geometric shape may be a circle, a rectangle, a rectangle with rounded edges, a triangle or the like. By using a solidly filled geometric shape as the graphical symbol, the graphical symbol can still be easily recognized even at small sizes.

The points of interest may be associated with two or more point of interest-categories to each of which a different display color can be assigned. The graphical symbol displayed for such point of interest may comprises the two or more display colors of the two or more associated point of interest-categories. This way, further information on the POIs can be provided to the user even for POIs located further away from the view point and being displayed at smaller sizes. As an example, two categories may be assigned to a POI, and two halves of the graphical symbol may be displayed in the two display colors, e.g., each half may be filled with one display color. The top and bottom half or the left and right half of the graphical symbol may be displayed each in a different display color.

If three or more point of interest-categories are associated with a point of interest, the graphical symbol displayed for such point of interest may be displayed in a predetermined color irrespective of the display colors assigned to the three or more point of interest-categories. This may achieve a better readability on small displays with small symbols, e.g., for symbols of a size of only 6×6 pixel and below.

According to an embodiment, the method may further comprise the steps of determining for each point of interest to be displayed in the geographical area a distance measure indicative of a distance of the point of interest to the view point of the perspective view and, in dependence on the distance measure, of determining for each of the points of interest the size of the graphical symbol to be displayed for the respective point of interest, wherein the size of the graphical symbol depends on the distance measure such that for a larger distance measure, the size of the graphical symbol becomes smaller. The change in size for different values of the distance measure does not need to be continuous, but a range of values of the distance measure may correspond to a particular size of the graphical symbol. The size of the graphical symbol may be determined by querying a database with the distance measure and retrieving the graphical symbol of the associated size from the database, or by retrieving a value for the size from the database. The graphical symbol to be displayed for a particular POI may thus be obtained by retrieving the graphical symbol of the determined size from, e.g., a symbol database, or by retrieving a graphical symbol having a default size and scaling the graphical symbol to the desired size that was determined for the POI (i.e., the retrieved size value). A perspective impression of location of the POIs can thus be achieved in an efficient way.

Determining the size of the graphical symbol may comprise retrieving the graphical symbol having the desired size from a database which associates different values of the distance measure with different sizes of the graphical symbols and which further associates each point of interest-category with the respective display color of the graphical symbol. From such database, a color value may be retrieved for coloring the retrieved graphical symbol, or the graphical symbol may directly be retrieved in the display color associated with the respective point of interest category.

Determining the size of the graphical symbol may comprise, in another embodiment, retrieving a size value from a database which associates different values of the distance measure with different sizes values of the graphical symbols. The database may further associate each point of interest-category with the respective display color of the graphical symbol. The graphical symbol may be obtained by retrieving a graphical symbol of a default size from, e.g., a symbol database and scaling the graphical symbol in accordance with the size value. The graphical symbol may be retrieved in the display color or may be colored in accordance with the display color.

Larger values of the distance measure may be associated with smaller sizes of the graphical symbol in the database. From such database, the color and size of a graphical symbol to be displayed for a POI can thus be obtained. As an example a bitmap or vector image of the correct color and/or correct size may be directly obtained or a link/pointer to such image may be obtained, or values for color and/or size may be obtained and used to scaling and/or coloring a default bitmap or vector image. The database may be a separate symbol database, or it may part of a POI database or a map database storing the data for generating the perspective view of the geographical area.

The method may further comprise retrieving the POI and the associated POI category from a database, e.g., a POI database. The POI database may be a separate database, or it may be integrated with the above mentioned symbol database and/or map database.

The distance measure may for example be a distance of the point of interest to the view point, a distance of the point of interest to a projection of the view point onto the geographical area, a distance from a current position determined by the navigation device or selected by a user to the point of interest, or a distance from a current position to the point of interest along one or more road segments. Besides providing a perspective impression, the latter may further provide information to the user about the driving distance to the POI. The distance measure may disregard any elevation in vertical direction of the view point, i.e., the height position of the view point above the surface of the geographical area. The distance measure may be a straight line distance, i.e., disregarding obstacles like mountains or buildings in its path.

In an embodiment, for points of interest for which the distance measure is smaller than a predetermined value, the graphical symbols displayed for the points of interest are pictograms indicative of a point of interest-type or the point of interest-category of the respective point of interest. The pictograms are displayed in the display color assigned to the point of interest-category associated with the respective point of interest. As an example, the pictograms may comprise lines and/or filled areas which are displayed in the display color. All colored pixels of the pictogram may be in the display color. For points of interest for which the distance measure is larger than the predetermined value, the graphical symbols displayed for such points of interest are geometric shapes solidly filled with the display color assigned to the point of interest-category associated with the respective point of interest. Again, all colored pixels of the geometric shape may be in the display color. The pictograms and/or the geometric shapes may comprise a frame of a different color, e.g., a black frame.

Such a configuration of displaying of the POIs may achieve a double indication of the POI category for closer POIs (by color and by pictogram), and a single indication and good visibility of POIs that are further away (by color and solid shapes) and further, a distance encoding by the size of the graphical symbols for the POIs. Recognition and selection of a particular POI is thus facilitated.

A further embodiment provides a navigation device comprising a display for displaying a perspective view of a geographical area, an interface to a (first) database which stores geographical data and points of interest for the geographical data and a processing unit. The processing unit is configured to perform the steps of displaying a perspective view of a geographical area on the display, and displaying points of interest as graphical symbols in the perspective view. The size of each graphical symbol is dependent on the distance of the respective point of interest from a view point of the perspective view, such that graphical symbols for points of interest located further away from the view point are displayed smaller than graphical symbols for points of interest located closer to the view point, so that a perspective impression of the distance to the points of interest is obtained. Each point of interest is associated with a point of interest-category, wherein to different point of interest-categories, different display colors are assigned. At least graphical symbols having a size smaller than a predetermined minimum size are displayed in the display color of the point of interest-category associated with the respective point of interest. By the navigation device, similar advantages as those outlined further above with respect to the inventive method may be achieved.

In an embodiment, the navigation device may comprise a (second) database which associates each point of interest with the respective point of interest-category and each point of interest category with the assigned display color. This (second) database may be a separate database, e.g., a symbol database, or it may be part of the (first) database storing the geographical data and points of interest (which first database may e.g., comprise a map database and a POI database, or a combined map/POI database).

The (second) database which associates the point of interest category with the assigned display color may further associate a distance measure indicative of a distance between a view point of the perspective view and a point of interest with different sizes of the graphical symbol of the point of interest, such that larger values of the distance measure are associated with smaller sizes of the graphical symbol. The value or a value range of the distance measure may for example be associated with a size value, a pointer/link to a graphical symbol of a particular size or directly with a graphical symbol of a particular size.

The navigation device may be configured to perform any of the above mentioned methods. In particular, the processing unit may be configured to perform any of the methods described above.

Furthermore, a computer program product is provided that can be loaded into the internal memory of a computing device, the product comprising executable program instructions that perform any of the above mentioned methods when the product is executed. The computer program product may be provided on a data carrier.

Further, an electronically readable data carrier is provided with stored electronically readable control information configured such that when using the data carrier in a computing device, the control information performs any of the above mentioned methods.

The features of the embodiments described above and further below may be combined with each other unless noted to the contrary.

These and other objects, features and advantages of the present invention will become apparent in light of the detailed description of the embodiments thereof, as illustrated in the accompanying drawings. In the figures, like reference numerals designate corresponding parts.

### DESCRIPTION OF THE DRAWINGS

The foregoing and other features and advantages of the invention will become further apparent from the following detailed description read in conjunction with the accompanying drawings. In the drawings like reference numerals refer to like elements.

FIG. 1 is a schematic block diagram illustrating a navigation device according to an embodiment of the invention;

FIG. 2 is a flow diagram illustrating a method of displaying POIs according to an embodiment of the invention;

FIG. 3 is a flow diagram illustrating the obtaining of a graphical symbol for a POI in accordance with an embodiment of the invention, which may be used in the method of FIG. 2;

FIG. 4 is a flow diagram illustrating the obtaining of a graphical symbol for a POI in accordance with an embodiment of the invention, which may be used in the method of FIG. 2;

FIG. 5 illustrates an example of a database which associates a POI category with a display color and a distance measure with a size of a graphical symbol in accordance with an embodiment of the invention; and

FIG. 6 is an example of a perspective view comprising POIs displayed in accordance with an embodiment of the invention, wherein the POIs are color coded and POIs that are further away are displayed using smaller graphical symbols.

### DETAILED DESCRIPTION OF THE INVENTION

It is to be understood that the following description of embodiments is given only for the purpose of illustration and is not to be taken in a limiting sense. It should be noted that the drawings are to be regarded as being schematic representations only, and elements in the drawings are not necessarily to scale with each other. Rather, the representation of the various elements is chosen such that their function and general purpose become apparent to a person skilled in the art.

The partitioning of embodiments in functional blocks or units shown in the drawings is not to be construed as indicating that these units necessarily are implemented as physically separate units, but functional blocks or units shown or described may be implemented as separate units, circuits, chips or circuit elements, but one or more functional blocks or units may as well be implemented in a common circuit, chip, circuit element or unit.

The determining and displaying of a perspective view in accordance with embodiments of the invention is not limited to a particular type of the displayed information. The perspective view of the geographical area may for example be a view of a map section at an elevated angle, or an inclined view of an satellite image of the geographical area, or a rendered image of the geographical area, such as a topology image, or any combination thereof. As an example, map data may be overlaid on a satellite image and a perspective view of this overlay may be determined, which may in addition comprise rendered objects, such as buildings, monuments, mountains or the like. The view point of the perspective view of the geographical area can correspond to the camera position from which the perspective view is seen, e.g., the camera position from which the perspective view is rendered. The view point may also be termed observer, viewers eye or simply viewer. An impression of perspective can be obtained by making objects that are located further away from the view point smaller, as this corresponds to the human perception of distance.

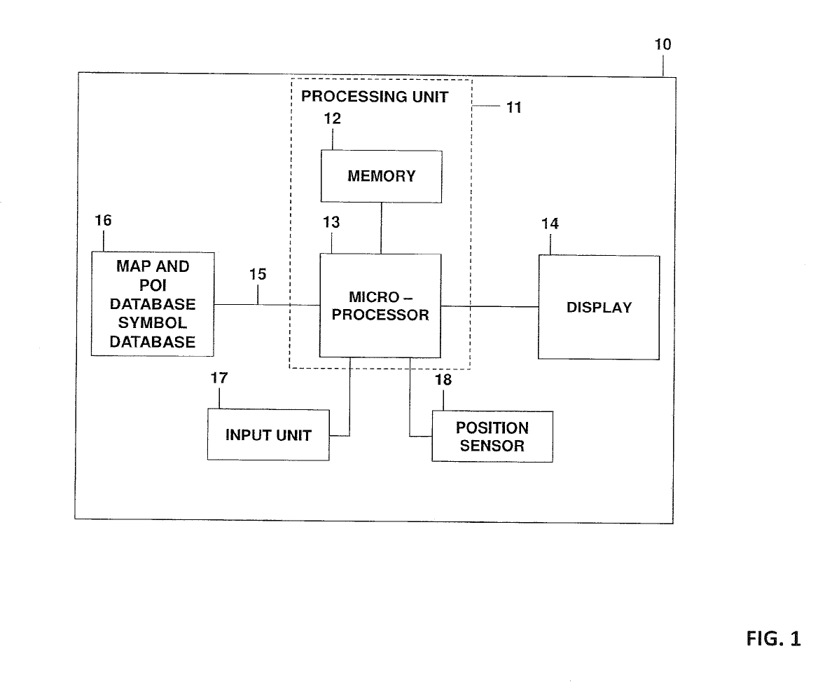

The schematic block diagram of FIG. 1 illustrates an navigation device 10 in accordance with an embodiment of the invention. The navigation device 10 comprises a processing unit 11 which includes a microprocessor 13 interfacing a memory 12. The navigation device 10 operates in accordance with control instructions stored in memory 12 and executed on microprocessor 13. The memory 12 may comprise all types of memory, volatile or non-volatile memory, such as random access memory, read only memory, flash memory, solid state memory, a hard disk and the like. The microprocessor 13 may comprise a single or multiple microprocessors, a special purpose microprocessor or the like.

The navigation device 10 further includes a display 14, input unit 17 and a position sensor 18 each interfacing the processing unit 11. The display 14 can be a liquid crystal display, a OLED display or any other type of display suitable for a navigation device. The input unit 17 may comprise buttons or keys disposed on the navigation device 10 or remote therefrom, it may further comprise a touch panel or touch screen, and it may thus be integrated in one component with the display 14. The input unit 17 and the display 14 provide a user interface (or human machine interface) by which information can be presented to a user of the navigation device 10 and the user can control functions of the navigation device 10.

The processing unit 11 is configured to operate a navigation application, e.g., by corresponding software instruction which are stored in the memory 12 and executed on the microprocessor 13. The navigation application can obtain information on the current position of the navigation device 10 by the position sensor 18. The position sensor 18 can be a GPS (global positioning system) position sensor which receives and evaluates position signals from satellites. The navigation application can further enable the user to enter a destination to which the user wants to travel, and may then determine a route from the current position to the destination in accordance with known methods.

For this purpose, the processing unit 11 comprises an interface 15 to a database 16. The database 16 comprises a map database which stores map data for geographical areas, including road segments and their positions. The map database 16 may comprise further information on geographical areas, such as satellite images of the geographical areas, topology information for the geographical areas, and so on. The database 16 can be part of the navigation device 10, as shown in FIG. 1. In other configurations, the database 16 may comprise a part that is local and part of the navigation device 10 and a further part that is remote and may accessed by a data connection by the navigation device 10, e.g., by a network connection, a mobile phone (data) connection, a wireless network connection, or the like. The interface 15 may in such configuration be coupled to a transceiver, e.g., a wireless network transceiver or mobile phone transceiver, via which the processing unit 11 can communicate with this part of the database 16. In other configurations, the database 16 may entirely be a remote database.

The processing unit 11 can access the map data in the database 16 via the interface 15 for determining a route along road segments. It is further configured to access the map data and/or the satellite images and/or the topology information for generating an image of a geographical area to be displayed to a user of the navigation device. The image may show a map section or a satellite image for the geographical area or the like, as mentioned above. The image may be a top view of the geographical area, but the processing unit 11 is also configured to generate a perspective view of the geographical area.

For generating the perspective view, the processing unit 11 may select a view point in accordance with a current position of the navigation device 10 (e.g., determined by the position sensor 18) or in accordance with user input. The view point may be selected slightly above and behind the current position (as seen in the viewing direction), so that the position of the navigation device (e.g., in a vehicle) still falls within the perspective view, or it may be selected at or above the current position, so that the perspective view corresponds to the view as seen from the navigation device. If the navigation device is positioned inside a vehicle, the viewing direction of the perspective view may be chosen in accordance with the driving direction of the vehicle. This applies also for other types of movement of the navigation device 10 (e.g., when installed on another type of vessel, when walking with the navigation device or the like).

It is also possible that the view point is selected by the user, in correspondence to the panning of a map in a top view.

The determination of the perspective view from map data, which may be flat, from images and/or from topology information can occur according to any method known in the art. The perspective view may be obtained by scaling/distortion of the data, or preferably by rendering an image of the data.

It should be clear that the navigation device 10 may comprise further components that are not depicted in FIG. 1 for the sake of brevity. In particular, it may comprise any components common to navigation devices known in the art.

The navigation device 10 may be any type of navigation device, portable or mounted. It may be a personal navigation device (PND), a vehicle or vessel mounted navigation device, a device implementing navigational functionality such as a smart phone, a laptop, a personal digital assistant (PDA), or the like.

In the embodiment of FIG. 1, the processing unit 11 is further configured to display points of interest (POIs) in a perspective view of a geographical area on the display 14. The POIs can be stored in the map database of the database 16, or the database 16 may comprise a separate POI database. POI data stored therein may for example associate geographical coordinates at which the POI is located with a certain type of POI, such as gas station, restaurant, or the like, and further with information on the POI (e.g., POI category). For POIs located in the perspective view to be displayed, the processing unit is configured to retrieve a pictogram that represents the POI type and display the pictogram at the geographical location of the POI in the perspective view, so that the user is informed about the existence of corresponding facility at this location. The graphical symbol may be retrieved from the map or POI database, or the database 16 may comprise a separate symbol database.

The processing unit 11 is configured to display the graphical symbol for a POI at a size that corresponds to the distance of the POI to the view point of the perspective view, so that POIs located further away from the view point are indicated as smaller graphical symbols in the perspective view. This creates an impression of perspective, and by the size of the graphical symbol, the user is enabled to judge the distance to the POI. The user thus obtains a natural and ergonomic view of the geographical area in which POIs are highlighted by the graphical symbols.

Furthermore, the processing unit 11 is adapted to determine the category of the POIs to be displayed in the geographical area. The POI category may be retrieved from the database 16 storing the POI data (e.g., from the map database or the POI database). The POI category may also be user assigned and stored in the database 16. The processing unit 11 may also be provided with a set of rules for associating certain types of POIs with predetermined POI categories. The processing unit 11 is configured to display at least graphical symbols having a size smaller than a predetermined minimum size in a display color that is associated with the POI category of the respective POI. In other configurations, it can display the graphical symbols irrespective of their size in the display color.

The processing unit 11 can be configured in different ways for displaying the graphical symbols for the POIs at a particular size and in a particular color. The database 16 may comprise a symbol database and, in dependence on the POI category and the distance of the POI to the view point, the processing unit can retrieve the graphical symbol of the required type, size and color for displaying. It is also possible that the graphical symbols are provided in a default color, and that the processing unit retrieves the color for the POI from the database 16 and changes the color of the graphical symbol in accordance. It is also contemplated that the graphical symbols are provided in a default size, or are provided as vector images, and the processing unit retrieves the size of the graphical symbol from the database 16 in accordance with the distance measure and scales the graphical symbol in accordance with the retrieved size. It is also contemplated that the processing unit 11 implements a set of rules for determining the size from the distance measure, e.g., by a conversion table or formula.

The graphical symbols (at least the more distant ones) are thus color coded in accordance with the POI category of the respective POI. Even for POIs located further away and thus displayed at smaller sizes in the perspective view, the user is thus enabled to determine the category of the POI. This is particularly helpful when the graphical symbols become so small that e.g., a pictogram indicating the POI type or category can no longer be recognized by the user. At least at and below such sizes, the processing unit 11 implements the color coding. At or below such sizes at which graphical symbols in form of pictograms can no longer be recognized, the processing unit may substitute the pictogram by a geometrical shape, thereby further increasing the visibility of smaller graphical symbols in the perspective view.

The above mentioned configuration of the processing unit 11 may be achieved by corresponding control instructions stored in the memory 12 and executed on the microprocessor 13.

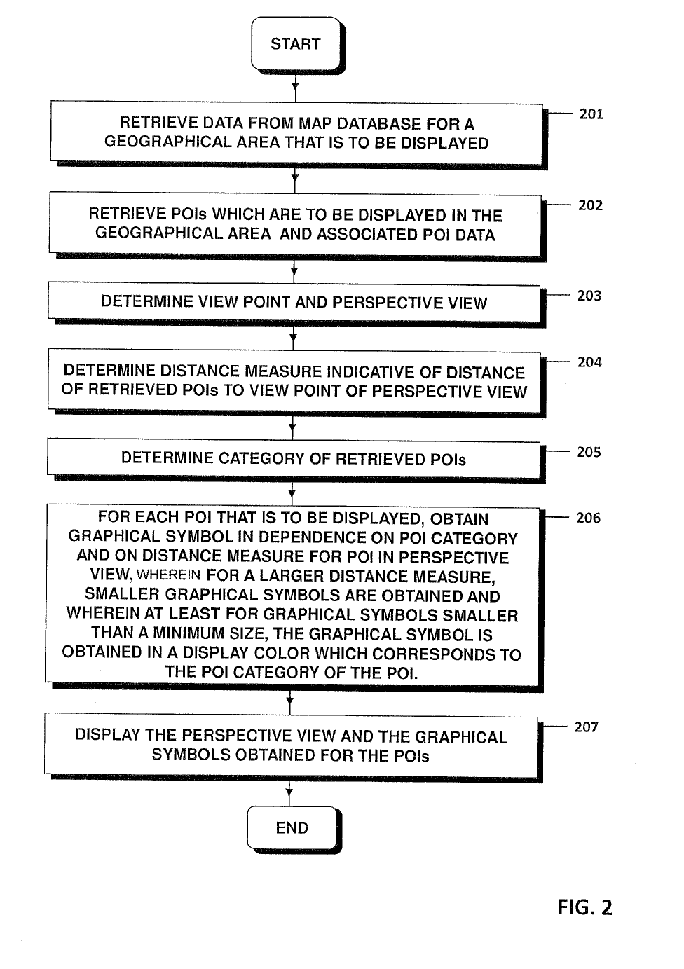

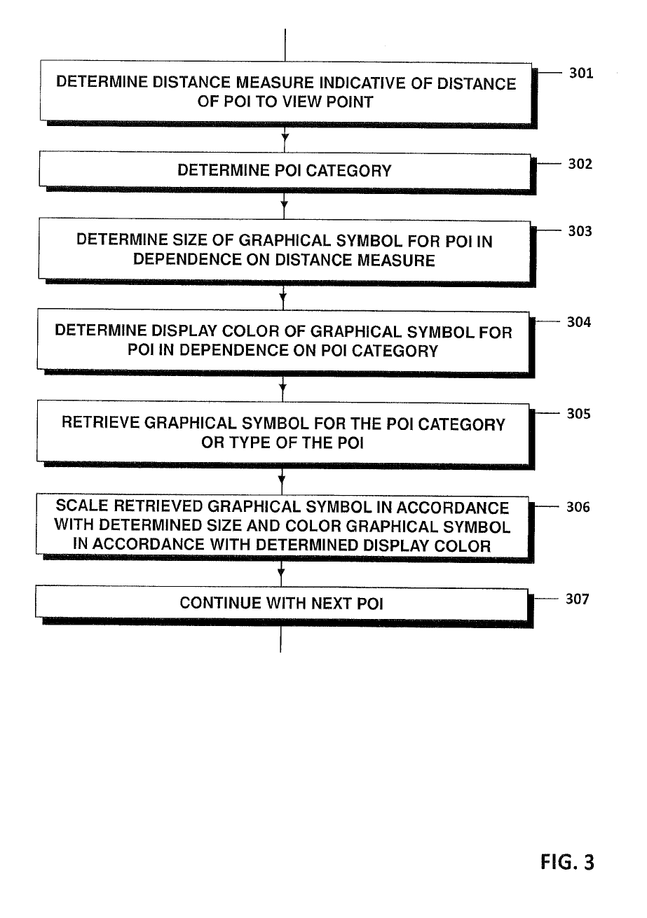

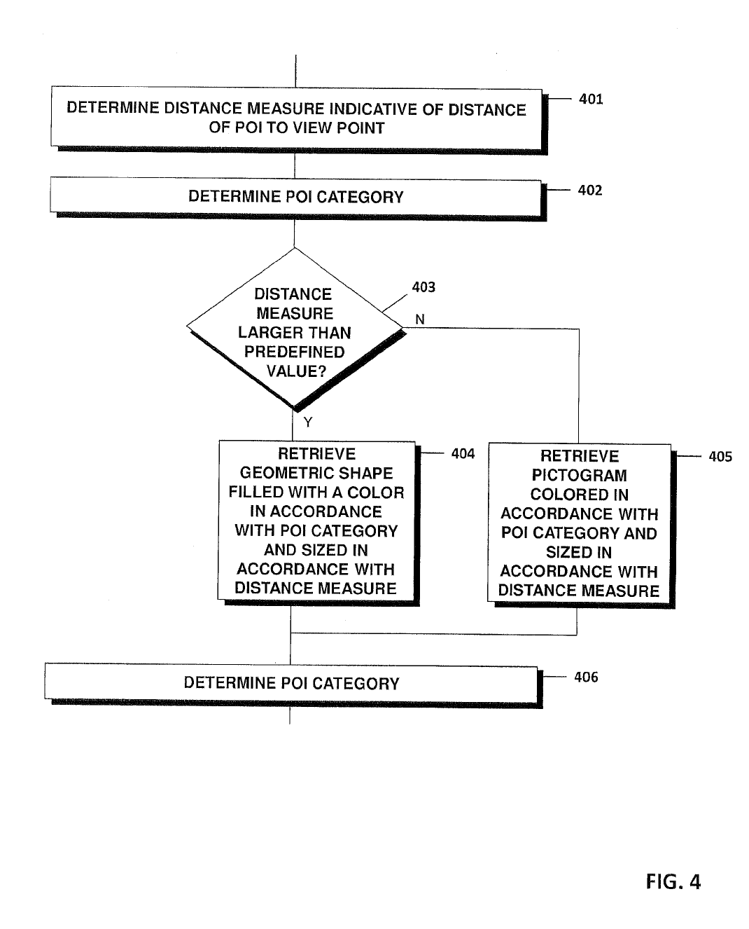

FIG. 2 is a flow diagram of a method according to an embodiment of the invention. In particular, the processing unit 11 may be configured to carry out the steps of the method illustrated in FIG. 2. Consequently, the explanations given above equally apply to the method of FIG. 2, and the subsequent FIGS. 3 and 4 which show flow diagrams of possible implementations of the method.

In a first step 201, the data necessary for displaying the desired perspective view of the geographical area is retrieved from the map database, which is part of database 16. This may include the determination of the current position of the navigation device by the position sensor 18, and the retrieving of the data for an area surrounding the current position. In the next step 202, the POIs are retrieved which are to be displayed in the perspective view. All POIs comprised within the geographical area may be retrieved, or only preselected POIs may be retrieved, e.g., selected according to the setting of the navigation device or according to user preferences/input. The POIs may are retrieved from the database 16, e.g., from the map database or a separate POI database.

The view point and the perspective view are determined in step 203. The view point may correspond to the current position of the navigation device, and the viewing direction may further be determined. It may for example correspond to a direction of motion of the navigation device. Determining the perspective view may include the rendering of an image from the retrieved data using the determined view point and viewing direction.

In a next step 204, a distance measure indicative of distance of the retrieved POIs to the view point of perspective view is determined. The distance measure may be, but does not need to be, the distance between the view point and the respective POI, in particular a straight line distance. The distance measure may for example be a straight line distance between the POI and the current position of the navigation device on the map, or to a projection of the viewpoint onto the map (i.e., the XY position on the map without taking the Z-Position or height of the view point above the map into account). Other possibilities of determining the distance measure are also conceivable, e.g., taking a distance from the current position to the POI along road segments.

The category of the retrieved POIs is determined in step 205. The category may be retrieved as part of POI data from the database 16 in the step 202. In may be determined in different ways, e.g., by user specifications associating particular types of POIs with a POI category. Such associations may be stored in a table as part of the database.

For each POI that is to be displayed, a graphical symbol is obtained in dependence on the POI category and on the distance measure for the POI in the perspective view (step 206), such that for a larger distance measure, smaller graphical symbols are obtained. At least for graphical symbols smaller than a minimum size, the graphical symbol is obtained in a display color which corresponds to the POI category of the POI. Possibilities for obtaining the graphical symbols in the desired color and size are described further below with respect to FIGS. 3 and 4. As mentioned above, the graphical symbols may be obtained by retrieving the graphical symbol in the desired size and color from a symbol database (which may be part of the database 16), or by scaling and/or coloring a default graphical symbol or by a combination of these possibilities.

In step 207, the perspective view and the graphical symbols obtained for the POIs are displayed on the display of the navigation device. The graphical symbols are displayed at or in proximity to the location of the respective POI in the geographical area. The user thus obtains an image on the display in which a perspective impression of the location of the POIs is achieved while at the same time, the category of the POIs is recognizable even for POIs indicated with relatively small graphical symbols.

Note that the above steps may also be carried out in a different order, the view point may for example be determined before retrieving the data from the map database so that the amount of data to be retrieved can be minimized.

FIG. 3 illustrates method steps of an embodiment of obtaining a graphical symbol for a POI which may be repeated for each POI to be displayed. The steps are a specific implementation of steps 204, 205 and 206 of the method of FIG. 2.

In steps 301 and 302, the distance measure and the POI category are determined for the POI under consideration, e.g., as outlined with respect to FIG. 2. In dependence on the distance measure, the size of the graphical symbol for the POI is determined (step 303). The size may be retrieved from a table (comprised, e.g., in the symbol or POI database) which associates ranges of the distance measure with predefined sizes of the graphical symbol. These may be different for different types of the display 14 and may further change according to user settings.

In step 304, the display color of the graphical symbol for the POI is determined in dependence on POI category. Again, this may be performed by making use of a table which associates the different POI categories each with a different display color. The table may be part of the POI or the symbol database.

The graphical symbol for the POI category of the POI is retrieved in step 305, e.g., from a symbol database which forms part of the database 16. The graphical symbol may be of a default color (e.g., in black) and size, it may be a bitmap or a vector graphic. The graphical symbol is for example a pictogram which represents the type or the category of the POI. Preferably, the pictogram represents the POI type, e.g., ‘gas station’, while the POI coloring represents the POI category, e.g., ‘vehicle’.

When retrieving the graphical symbol, a differentiation may be made for different sizes (or correspondingly different values of the distance measure) determined for the POI. For sizes below a predetermined minimum size, a geometric shape may be retrieved for the graphical symbol while for larger sizes, the above mentioned pictogram may be retrieved. The geometric shape may be of any suitable type, such as a rectangle or square, possibly having rounded edges, a triangle, circle, diamond or the like. This can provide better visibility of the smaller graphical symbols.

In step 306, the retrieved graphical symbol is scaled in accordance with the determined size and is colored in accordance with determined display color. After scaling and coloring, the graphical symbol is ready to be displayed in the perspective view. The steps are repeated for the remaining POIs to be displayed (step 307), and the method continues with step 207 of FIG. 2.

By the method of FIG. 3, only a small number of graphical symbols needs to be stored, since only one pictogram is required per POI type and only a single geometric shape needs to be provided. Storage space may thus be conserved.

Similarly, the method steps shown in FIG. 4 are a particular implementation of steps 204-206 of FIG. 2, the steps being performed for each POI to be displayed in the perspective view.

In step 401 and 402, the distance measure and the POI category are determined for the POI under consideration, e.g., as outlined with respect to FIG. 2. In decision step 403, it is determined whether the distance measure is larger than a predefined value. In the affirmative, a geometric shape filled with a color in accordance with POI category and sized in accordance with the distance measure is retrieved (step 404). If the decision is negative, a pictogram colored in accordance with the POI category and sized in accordance with distance measure is retrieved, the pictogram being indicative of the POI type or category (step 405).

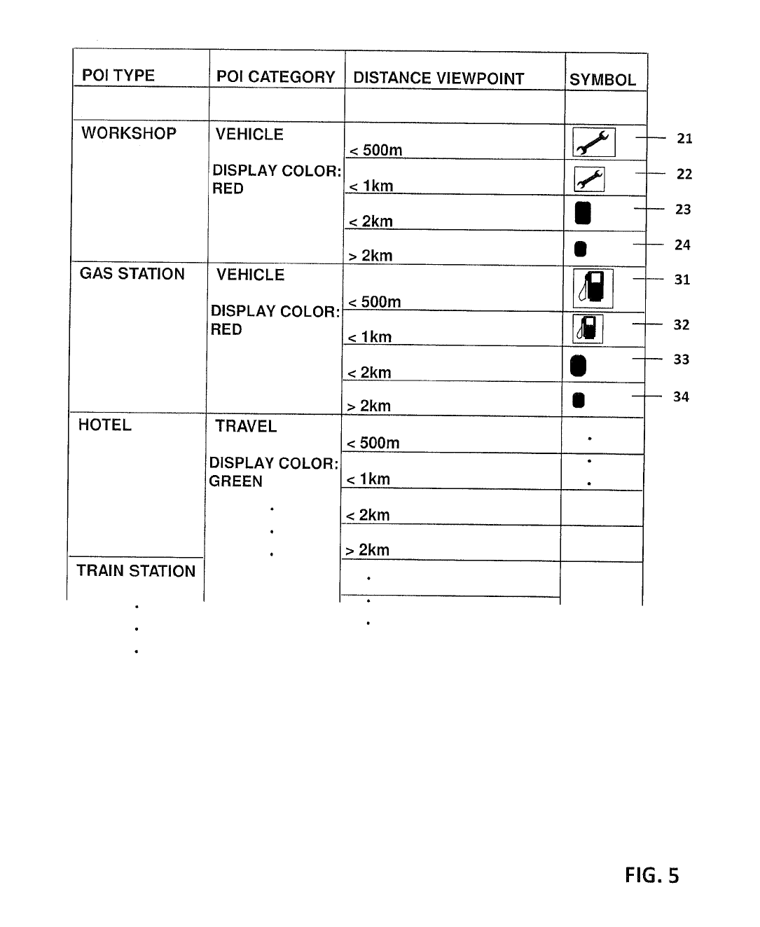

The pictogram and/or geometric shape is retrieved from a symbol database forming part of the database 16. An example of a table of the symbol database is depicted in FIG. 5. The first column shows the POI type and the second column shows the associated POI category. Note that POI type and category can be retrieved as part of the POI data from the POI or map database. For each POI type, the third column comprises ranges of the distance measure. For each of these ranges, the fourth column comprises a graphical symbol of the appropriate size. For larger sizes (smaller value of the distance measure), the graphical symbol is a pictogram 21, 22, 31, 32 indicating the POI type (here for the first row: a wrench 21, 22 indicating the POI type ‘workshop’). For smaller sizes, the graphical symbol 23, 24, 33, 34 is a rectangle with rounded edges. The symbols have a color that is associated with the POI category. In the black and white drawing of FIG. 5, the display color is indicated in the second column of the table under POI category. The table can now be queried by POI type and the distance measure and will return a graphical symbol having the desired size and color, the color being indicative of the POI category. The table may in the last column for example comprise a link or a pointer to the respective graphical symbol. The decision step 403 of FIG. 4 may thus be implemented by a simple query to the database illustrated in FIG. 5.

Note that the second column of the table is provided for illustration purposes only and may be omitted. Similarly, the first column may be omitted if the pictogram is only representative of the POI category and POI category may then be used in the database query.

The desired graphical symbol can thus be retrieved in a straight forward manner. Turning back to FIG. 4, the method continues in step 406, where the next POI is processed accordingly. After graphical symbols were retrieved for each POI to be displayed in the perspective view, the method can continue with the step 207 in FIG. 2.

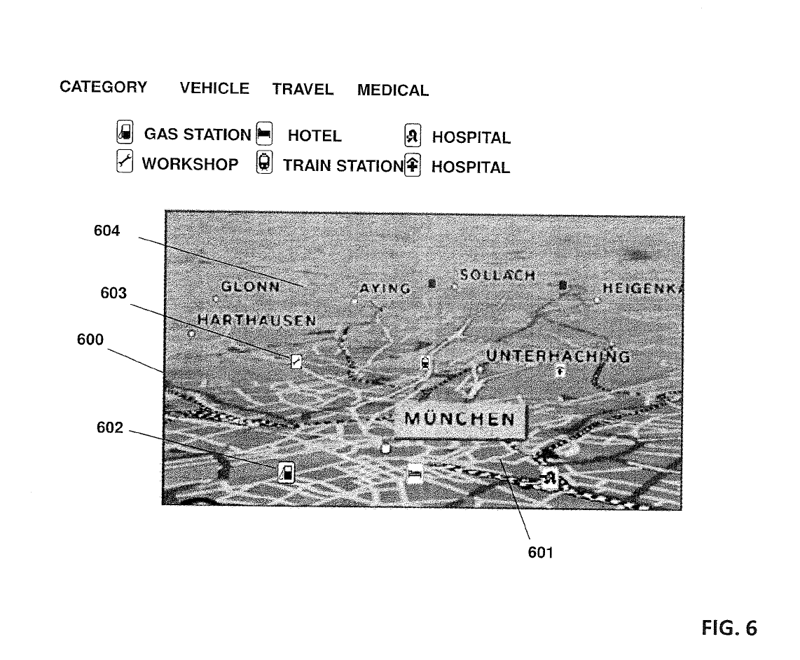

FIG. 6 illustrates a perspective view being displayed on the display 14 of the navigation device 10 as a result of the embodiments of the methods explained above. As can be seen, the perspective view 600 comprises geographical area 601 in form of a map section that is seen from a view point located slightly above the plane of the map. The perspective view 600 comprises POIs that are located at close to the view point (POI 602), at a medium distance to the view point (POI 603) and far from the view point (POI 603), which corresponds to increasing values of the distance measure.

The POIs of the type ‘gas station’ and ‘workshop’ are members of the category ‘vehicle’ and are shown in the display color ‘red’. The POIs of type ‘hotel’ and ‘train station’ are member of the POI category ‘travel’ and are shown in the display color ‘green’. The POIs of the type ‘pharmacy’ and ‘hospital’ are member of the category ‘medical’ and are shown in the display color ‘blue’. The display colors are given here in writing, since they will not be visible in the black and white image of FIG. 6.

As can be seen, the size of the graphical symbols decreases with a larger distance to the view point. For the POIs located far from the view point, no pictograms but geometric shapes are shown, as explained above. Note that in FIG. 6, the left shape is colored blue, while the middle and the right shape are colored in red. Accordingly, even though a pictogram may no longer be recognized in the perspective view 600 of FIG. 6, the user immediately knows that the far away POIs relate to medical services and vehicle services, respectively. Still, the user will notice, due to the perspective impression obtained from the different sizes, that these POIs are located rather far away. If the user is travelling in a vehicle and requires fuel, he can direct his travel towards a far away POI of the category ‘vehicle’, or may zoom in on the particular POI to determine whether it is a gas station or workshop. Note that zooming in will reduce the distance to the view point and will thus result in the graphical symbol taking on the form of a pictogram.

The features of the embodiments described above can be combined with each other. As an example, graphical symbols of different sizes may be retrieved from a database in the same color and may be colored with the display color afterwards. Modifications of the above embodiments are certainly conceivable. As an example, not the entire pictogram or geometrical shape needs to be colored in the display color, but only parts of it. ‘Displaying a graphical symbol in the display color’ is not to be construed to mean that the whole graphical symbol needs to be in the display color, but it is sufficient if parts of the graphical symbol are in the display color so that the display color is recognizable. As an example, a frame and/or a filled area of the graphical symbol may have the display color. It is also possible to have more than one display color in the graphical symbol. For example if a POI is member to two POI categories, the two display colors associated with the two POI categories can be comprised in the graphical symbol. For more than two POI categories, a default display color is preferably chosen, since the display colors will otherwise become difficult to identify.

In summary, the present invention provides an improved displaying of POIs in a perspective view, so that the distance to the POI and the POI category can be easily recognized by a user when looking at the display of the navigation device.

While specific embodiments of the invention are disclosed herein, various changes and modifications can be made without departing from the scope of the invention. The present embodiments are to be considered in all respects as illustrative and non-restrictive, and all changes coming within the meaning and equivalency range of the appended claims are intended to be embraced therein.

Although the present invention has been illustrated and described with respect to several preferred embodiments thereof, various changes, omissions and additions to the form and detail thereof, may be made therein, without departing from the spirit and scope of the invention.

What is claimed is:

1. A method of displaying points of interest in a perspective view of a geographical area on a display of a navigation device, the method comprising the steps of:
displaying a perspective view of the geographical area on the display of the navigation device;
displaying points of interest as graphical symbols in the perspective view, wherein the size of each graphical symbol is dependent on the distance of the respective point of interest from a view point of the perspective view, such that graphical symbols for points of interest located further away from the view point are displayed smaller than graphical symbols for points of interest located closer to the view point, and wherein each point of interest is associated with a point of interest-category,
wherein for different point of interest-categories, different display colors are assigned, and wherein at least graphical symbols having a size smaller than a predetermined minimum size are displayed in the display color of the point of interest-category associated with the respective point of interest.

2. The method according to claim 1, wherein the graphical symbols having a size smaller than the predetermined minimum size are geometric shapes that are solidly filled in the display color assigned to the point of interest-category of the respective point of interest.

3. The method according to claim 1, wherein the graphical symbols are displayed in the display color of the point of interest category associated with the respective point of interest irrespective of their size.

4. The method according to claim 1, wherein at least the graphical symbols having a size larger than the predetermined minimum size are pictograms indicative of the point of interest-type or the point of interest-category of the respective point of interest.

5. The method according to claim 1, wherein the points of interest can be associated with two or more point of interest-categories to each of which a different display color is assigned, wherein the graphical symbol displayed for such point of interest comprises the two or more display colors of the two or more associated point of interest-categories.

6. The method according to claim 5, wherein if three or more point of interest-categories are associated with a point of interest, the graphical symbol displayed for such point of interest is displayed in a predetermined color irrespective of the display colors assigned to the three or more point of interest-categories.

7. The method according to claim 1, wherein the method further comprises:
determining for each point of interest to be displayed in the perspective view a distance measure indicative of a distance of the point of interest to the view point of the perspective view;
in dependence on the distance measure, determining for each of the points of interest the size of the graphical symbol to be displayed for the respective point of interest, wherein the size of the graphical symbol depends on the distance measure such that for a larger distance measure, the size of the graphical symbol becomes smaller.

8. The method according to claim 7, wherein determining the size of the graphical symbol comprises retrieving the graphical symbol having the desired size from a database which associates different values of the distance measure with different sizes of the graphical symbols and which further associates each point of interest-category with the respective display color of the graphical symbol.

9. The method according to claim 7, wherein the distance measure is a distance of the point of interest to the view point, a distance of the point of interest to a projection of the view point onto the geographic area, a distance from a current position determined by the navigation device or selected by a user to the point of interest, or a distance from a current position to the point of interest along one or more road segments.

10. The method according to any of claims 7,
wherein for points of interest for which the distance measure is smaller than a predetermined value, the graphical symbols displayed for the points of interest are pictograms indicative of a point of interest-type or the point of interest-category of the respective point of interest, the pictograms being displayed in the display color assigned to the point of interest-category associated with the respective point of interest, and
wherein for points of interest for which the distance measure is larger than the predetermined value, the graphical symbols displayed for the points of interest are geometric shapes solidly filled with the display color assigned to the point of interest-category associated with the respective point of interest.

11. A navigation device, comprising:
a display for displaying a perspective view of a geographical area;
an interface to a database which stores geographical data and points of interest for the geographical data; and
a processing unit configured to perform the steps of
displaying a perspective view of a geographical area on the display;
displaying points of interest as graphical symbols in the perspective view, wherein the size of each graphical symbol is dependent on the distance of the respective point of interest from a view point of the perspective view, such that graphical symbols for points of interest located further away from the view point are displayed smaller than graphical symbols for points of interest located closer to the view point, wherein each point of interest is associated with a point of interest-category,
wherein to differentiate point of interest-categories, different display colors are assigned, and wherein at least graphical symbols having a size smaller than a predetermined minimum size are displayed in the display color of the point of interest-category associated with the respective point of interest.

12. The navigation device according to claim 11, further comprising a database which associates each point of interest with the respective point of interest-category and each point of interest category with the assigned display color.

13. The navigation device according to claim 12, wherein the database further associates a distance measure indicative of a distance between a view point of the perspective view and a point of interest with different sizes of the graphical symbol of the point of interest, such that larger values of the distance measure are associated with smaller sizes of the graphical symbol.

14. The navigation device according to claim 11, wherein the processing unit is configured to perform the method according to claim 1.

15. A computer program product that can be loaded into the internal memory of a computing device, the product comprising software code portions for performing the method of claim 1 when the product is executed.

16. Electronically readable data carrier with stored electronically readable control information configured such that when using the data carrier in a computing device, the control information performs the method of claim 1.
